(19) United States
(12) Patent Application Publication
(10) Pub. No.: US 2018/0189307 A1
(43) Pub. Date: Jul. 5, 2018

(54) TOPIC BASED INTELLIGENT ELECTRONIC FILE SEARCHING

(71) Applicant: Futurewei Technologies, Inc., Plano, TX (US)

(72) Inventors: Jiangsheng Yu, San Jose, CA (US); Hui Zang, Cupertino, CA (US)

(73) Assignee: Futurewei Technologies, Inc., Plano, TX (US)

(21) Appl. No.: 15/395,377

(22) Filed: Dec. 30, 2016

(51) Int. Cl. G06F 17/30

(52) U.S. Cl. CPC G06F 17/30106; G06F 17/30091; G06F 17/30112; G06F 17/3053; G06F 17/30315

(57) ABSTRACT

An apparatus comprises a non-transitory memory that stores a query for of electronic files and instructions. One or more processors execute the instructions to represent the plurality of electronic files as a plurality of column vectors. Each entry in a column vector represents a frequency of a word used in an electronic file. The query is represented as a query vector with each entry representing a frequency of a word used in the query. A topic space is formed from the plurality of column vectors. Each column vector in the term-document-matrix is projected into the topic space to obtain new representations of the plurality of electronic files. The query vector is projected into the topic space to obtain a new representation of the query. A similarity score is calculated between each representation of the electronic files with the representation of the query to obtain a plurality of similarity scores.

### BACKGROUND

Searching electronic files is often based on string matching of file names or character strings in a text of an electronic file. For example, a search may be based on matching a key word, or words, in a query to a file name or text in an electronic document. Keyword matching methods may locate all the occurrences of a particular pattern of a key word in an input string of text in an electronic file or file name. There are many types of pattern matching methods, such as a brute-force (BF), Knuth, Morris and Pratt (KMP), Boyer and Moore (BM) and Karp and Rabin (KP) methods.

### SUMMARY

In a first embodiment, the present technology relates to an apparatus that comprises a non-transitory memory that stores a query for a plurality of electronic files and instructions. One or more processors execute the instructions to represent the plurality of electronic files as a plurality of column vectors. Each entry in a column vector represents a frequency of a word used in an electronic file. The query is represented as a query vector with each entry representing a frequency of a word used in the query. A topic space is formed from the plurality of column vectors. Each column vector is projected into the topic space to obtain representations of the plurality of electronic files. The query vector is projected into the topic space to obtain a representation of the query. A similarity score is calculated between each representation of the electronic files with the representation of the query to obtain a plurality of similarity scores.

A second embodiment in accordance with the first embodiment, wherein the plurality of column vectors form a term-document-matrix, and wherein the representations of the plurality of electronic files include a plurality of linear combinations of topics represented as a plurality of numbers.

A third embodiment in accordance with the first through the second embodiments, wherein form a topic space includes calculate a singular value decomposition of the term-document-matrix to obtain a topic space.

A fourth embodiment in accordance with the first through the third embodiments, wherein the topic space includes at least two orthogonal column vectors from a first matrix calculated from the singular value decomposition.

A fifth embodiment in accordance with the first through the fourth embodiments, wherein the plurality of column vectors are m-dimensional column vectors and the topic space is a k-dimensional topic space, wherein k is less than m

A sixth embodiment in accordance with the first though the fifth embodiments, further comprising the one or more processors execute the instructions to rank the plurality of similarity scores to output a result that indicates an electronic file in the plurality of electronic files that is most relevant to the query.

In another embodiment, the present technology relates to a computer-implemented method for searching a plurality of electronic files in response to a query. The method comprises constructing a term-document-matrix from the plurality of electronic files. A column in the term-document-matrix represents an electronic file in the plurality of electronic files. Each value in the column represents a frequency of a word used in the electronic file. A query vector is constructed from the query. Each value in the query vector represents a frequency of a word used in the query. A singular value decomposition is performed on the term-document-matrix to obtain a topic space. Each column in the term-document-matrix is projected into the topic space to obtain a plurality of different representations of the plurality of electronic files. The query vector is projected into the topic space to obtain a different representation of the query. The plurality of electronic files are ranked based on a similarity comparison between each different representation of the electronic files and the different representation of the query.

In a further embodiment, the present technology relates to a non-transitory computer-readable medium storing computer instructions, that when executed by one or more processors, cause the one or more processors to perform steps. The steps include construct a lexicon from a plurality of electronic files. A term-document-matrix is constructed in response to the lexicon. A column in the term-document-matrix represents an electronic file in the plurality of electronic files. Each value in the column of the term-document-matrix represents a frequency of a word used in the electronic file. A query vector is constructed from a query. Each value in the query vector represents a frequency of a word used in the query. A singular value decomposition of the term-document-matrix is performed to obtain a topic space. Each column in the term-document-matrix is projected into the topic space to obtain a plurality of linear combinations of topics for the plurality of electronic files. The query vector s projected into the topic space to obtain a linear combination of topics for the query. Each linear combination in the plurality of linear combinations of topics is compared with the linear combination of topics for the query to obtain a plurality of similarity scores.

This Summary is provided to introduce a selection of concepts in a simplified form that are further described below in the Detailed Description. This Summary and/or headings are not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a block diagram that illustrates an apparatus for searching electronic files based on content according to embodiments of the present technology.

FIG. 2 is a flowchart that illustrates a method for searching electronic files based on content according to embodiments of the present technology.

FIG. 3 illustrates three electronic files having text to be searched based on a query according to embodiments of the present technology.

FIG. 4 illustrates tables to form a term-document-matrix of the three electronic files shown in FIG. 3 and a query vector according to embodiments of the present technology.

FIGS. 5A-B illustrates a single value decomposition having term (or topic) vectors and document vectors according to embodiments of the present technology.

FIG. 6 illustrates a query vector and a single value decomposition of a term-document-matrix to obtain similarity scores according to embodiments of the present technology.

FIGS. 7, 8A-B and 9 are flowcharts that illustrate methods for searching electronic files based on content according to embodiments of the present technology.

FIG. 10 is a block diagram that illustrates a software architecture according to embodiments of the present technology.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The present technology generally relates to intelligent searching based on content, rather than word matching of text or file names. Topic mining is used to understand the content of electronic files (or documents), which leads to intelligent searching. Results of content searching may be sorted by a degree of relevance to further aid in obtaining relevant information.

The present technology is capable of extracting related electronic files that do not necessarily contain query or key words. For example under a typical string matching method, an electronic file that includes the topic “singular value decomposition” may not be returned for a query that includes “matrix factorization” as key words. In contrast, the present technology would likely return such an electronic file that has “singular value decomposition” as a topic.

According to embodiments of the present technology, singular value decomposition may be used on a term-document-matrix that represents the content or topics of a plurality of electronic files. A topic space is then constructed from the resulting matrices. Representations of the documents as well as a query may be projected into the topic space to obtain linear combination of topics (or a plurality of number) of the documents and query. The topics are learned from the term-document-matrix, which are pairwise orthogonal vectors (each topic can be viewed as a linear combination of words). In the topic space, each document is further represented by a linear combination of topics (as a comparison, the original representation of each document is a linear combination of words). These linear combination of topics may be compared to obtain similarity scores that are used to rank the relevancy of each electronic file in the plurality of electronic files based on content.

The present technology provides embodiments that are different than typical sematic search. The present technology uses topic (or content) based searching, where the topic (or content) is a linear combination of words or numbers representing words. In contrast, a sematic search may use synonyms as an extension of a query. Semantic search may be based on pre-defined (static) word/concept ontology. Sematic search may not be applied to a new language before the ontology is built. Sematic search may not be applied to a certain domain where the knowledge between subject words may not be formulated as an ontology. Semantic search may include a static word relationship that may not change over different environments. The present technology includes embodiments in which topics are learned from observed or measured data. The present technology provides topics based on data instead of being predefined in embodiments.

It is understood that the present technology may be embodied in many different forms and should not be construed as being limited to the embodiments set forth herein. Rather, these embodiments are provided so that this disclosure will be thoroughly and completely understood. Indeed, the disclosure is intended to cover alternatives, modifications and equivalents of these embodiments, which are included within the scope and spirit of the disclosure as defined by the appended claims. Furthermore, in the following detailed description, numerous specific details are set forth in order to provide a thorough understanding of the technology. However, it will be clear that the technology may be practiced without such specific details.

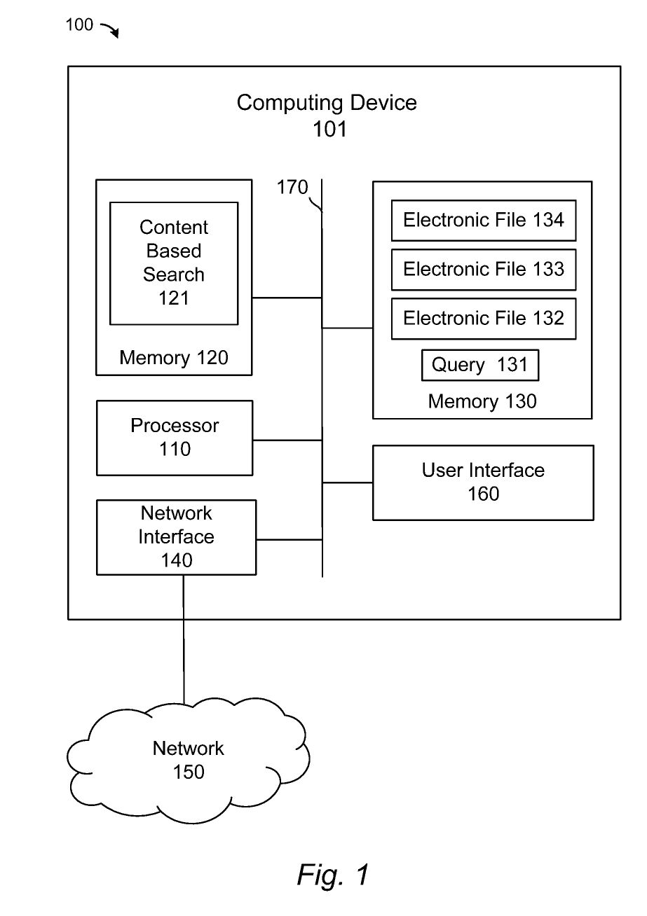

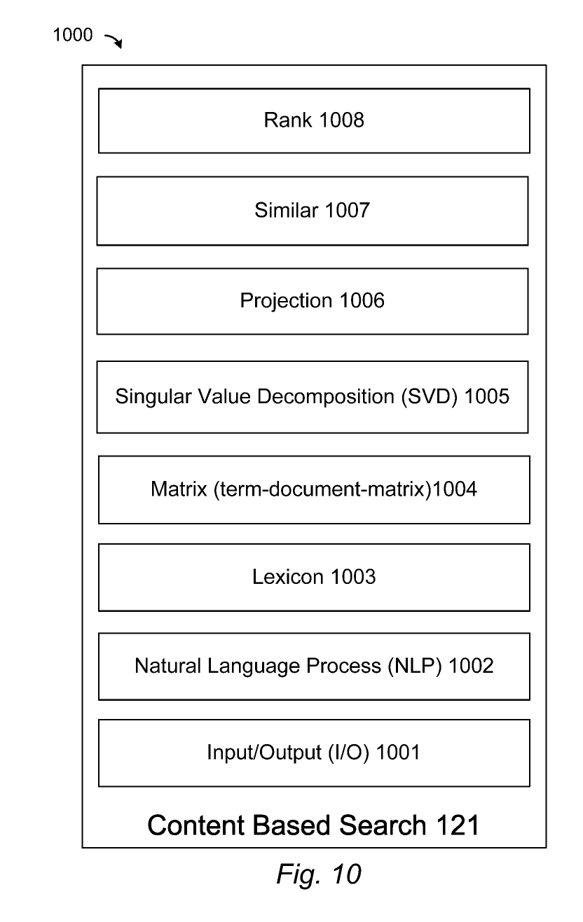

FIG. 1 illustrates a hardware architecture 100 of a computing device 101 for searching electronic files based on content according to embodiments of the present technology. As will be describe in detail herein, computing device 101 includes content based search 121 and electronic files 132-34 as well as query 131 that are software components stored in memories 120 and 130 of computing device 101. Processor 110 executes content based search 121 in order to search electronic files 132-134 for particular content in response to query 131. In embodiments, electronic files 132-134 as well as query 131 may be obtained from network 150 via network interface 140 and interconnect 170. An indication of the most relevant electronic file (such as a file name) of the electronic files 132-134 (or ranking) may be output to user interface 160 in response to the execution of content based search 121. A detailed description of computing device 101 as well as a software architecture of content based search 121 is described herein and further illustrated in the figures, including FIG. 10.

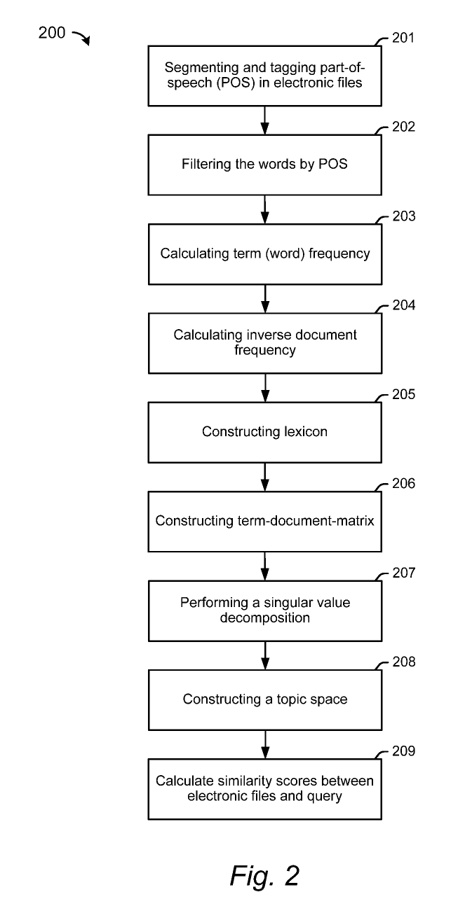

FIG. 2 is a flowchart that illustrates a method 200 for searching electronic files based on content according to embodiments of the present technology. In embodiments, methods shown in FIGS. 2, 7, 8A-B and 9 are computer-implemented methods performed, at least partly, by hardware and software components illustrated in FIGS. 1 and 11 and as described herein. In an embodiment, software components illustrated in FIG. 10, executed by one or more processors, such as processor 110 shown in FIG. 1, perform at least a portion of the methods.

In FIG. 2 at 201 a plurality of words are segmented and tagged with part-of-speech (POS) identification in an electronic file in the plurality of electronic files. In an embodiment, this function as well as the function at 202-204 are performed for each electronic file to be searched. In embodiments, content based search 121, in particular natural language process (NLP) 1002 as shown in FIG. 10, executed by processor 110 performs at least a portion of this function as well as the functions described below at 202-204.

At 202 the plurality of words is filtered in response to the parts-of-speech identification to obtain a set of words. For example, articles of speech (“a” and/or “the”) in an English language electronic file may be filtered or removed from the plurality of words to provide a plurality of words without articles of speech.

At 203 a frequency of each word in the set of words is calculated.

At 204 an inverse document frequency is calculated. In an embodiment, an inverse document frequency is a measure of how much information a word provides, that is, whether a term or word is common or rare across all documents or electronic files. In an embodiment, an inverse document frequency is the logarithmically scaled inverse fraction of the documents that contain the word, obtained by dividing the total number of documents by the number of documents containing the term, and then taking the logarithm of that quotient.

At 205 a lexicon is constructed in response to the inverse document frequency. In embodiments, content based search 121, in particular lexicon 1003, executed by processor 110 performs at least a portion of this function.

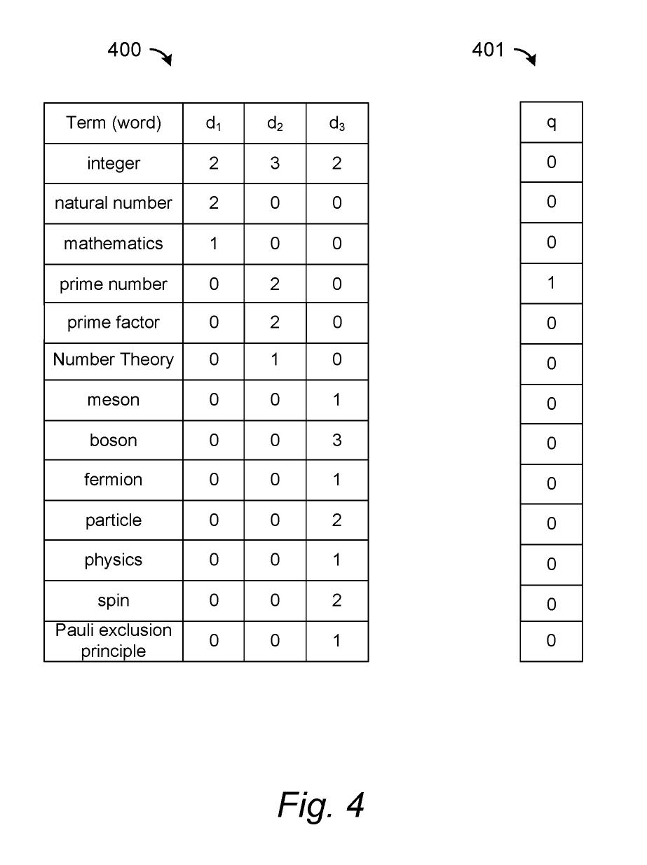

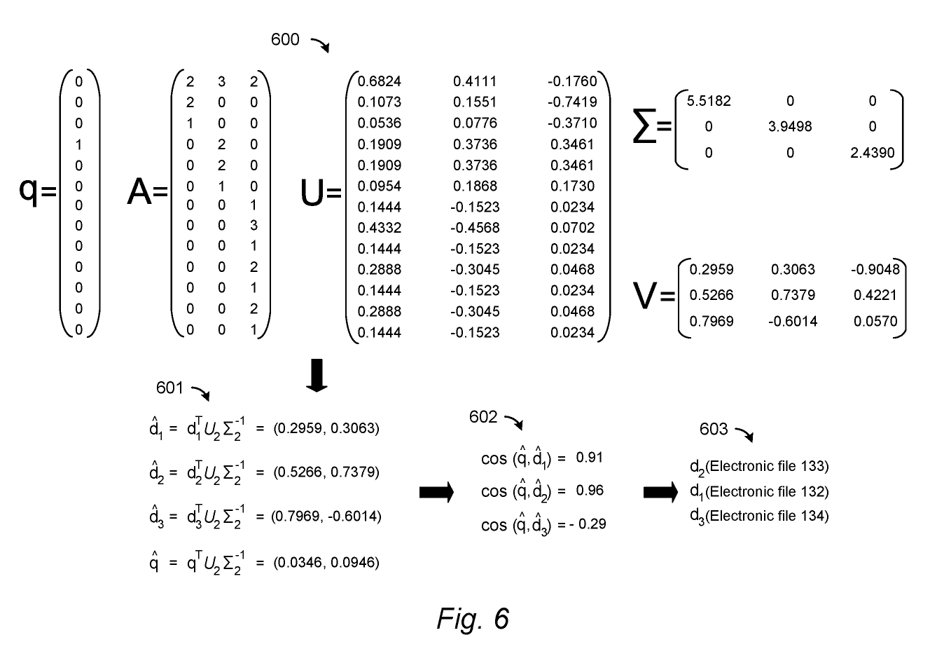

At 206 a term-document-matrix from the plurality of electronic files is constructed. A column in the term-document-matrix represents an electronic file in the plurality of electronic files and each value in the column in the term-document-matrix represents a frequency of a word used in the electronic file. In an embodiment, a term-document-matrix, such as number values from table 400 shown in FIG. 4 or as matrix A as shown in FIG. 6, is constructed in response to the words that are segmented and tagged. In embodiments, content based search 121, in particular matrix 1004, executed by processor 110 performs at least a portion of this function.

At 206 a query vector is also constructed from the query in an embodiment. A query vector represents the query and each value in the query vector represents a frequency of a word used in the query. In embodiments, content based search 121, in particular matrix 1004, executed by processor 110 performs at least a portion of this function.

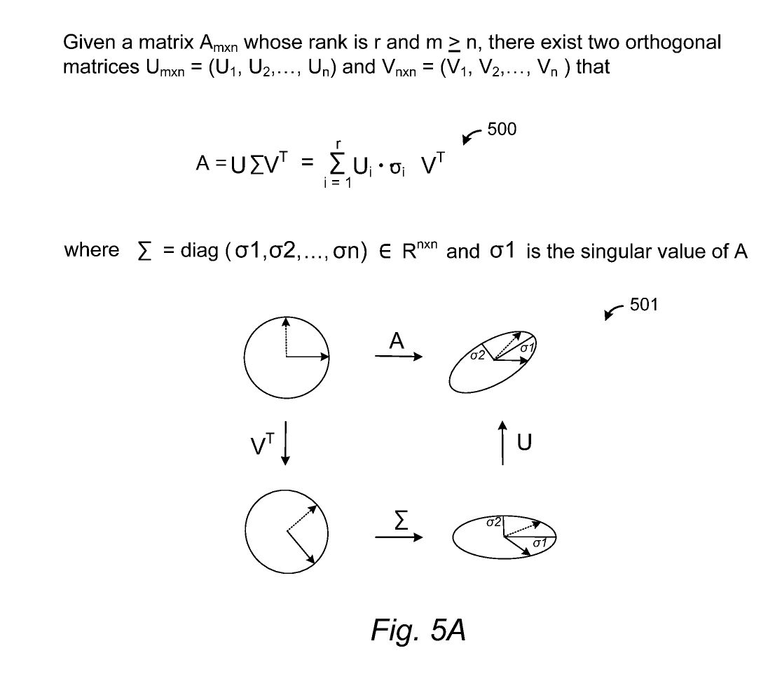

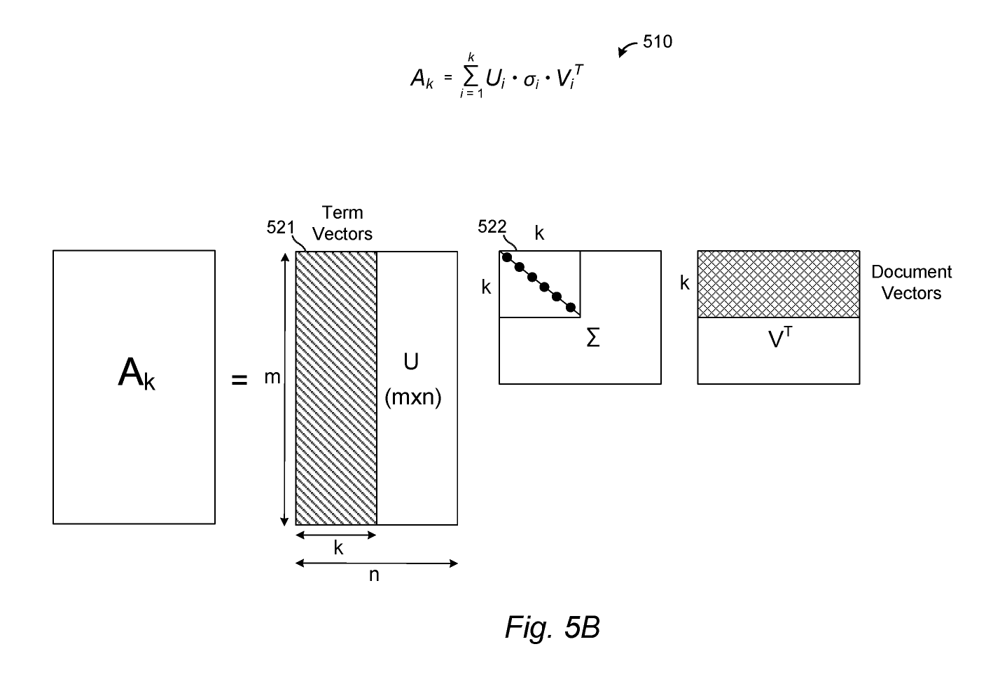

At 207 a singular value decomposition of the term-document-matrix is performed to obtain a topic space. In embodiments, content based search 121, in particular singular value decomposition (SVD) 1005 as shown in FIG. 10, executed by processor 110 performs at least a portion of this function. As described in detail herein, FIGS. 5A, 5B and 6 illustrate a SVD according to embodiments.

At 208 a topic space is constructed in response to the SVD at 207. In embodiments, each column in the term-document-matrix (or represented document) is projected into the topic space to obtain a plurality of linear combinations of topics for the plurality of electronic files. In embodiments, content based search 121, in particular projection 1006, executed by processor 110 performs at least a portion of this function.

Similarly, the query vector is projected into the topic space to obtain a linear combination of topics for the query. In embodiments, content based search 121, in particular projection 1006, executed by processor 110 performs at least a portion of this function.

At 209 similarity scores are calculated between the linear combination of topics representations of the electronic files and the query. In embodiments, content based search 121, in particular the function of similar 1007, executed by processor 110 performs at least a portion of the similarity score function. In further embodiments, calculated similarity scores may be used to rank or determine the most relevant electronic file. For example, indications of the plurality of electronic files (file names) are ordered from most to least relevant based on their respective similarity scores for the query. In embodiments, content based search 121, in particular the function of rank 1008, executed by processor 110 performs at least a portion of the ordering function.

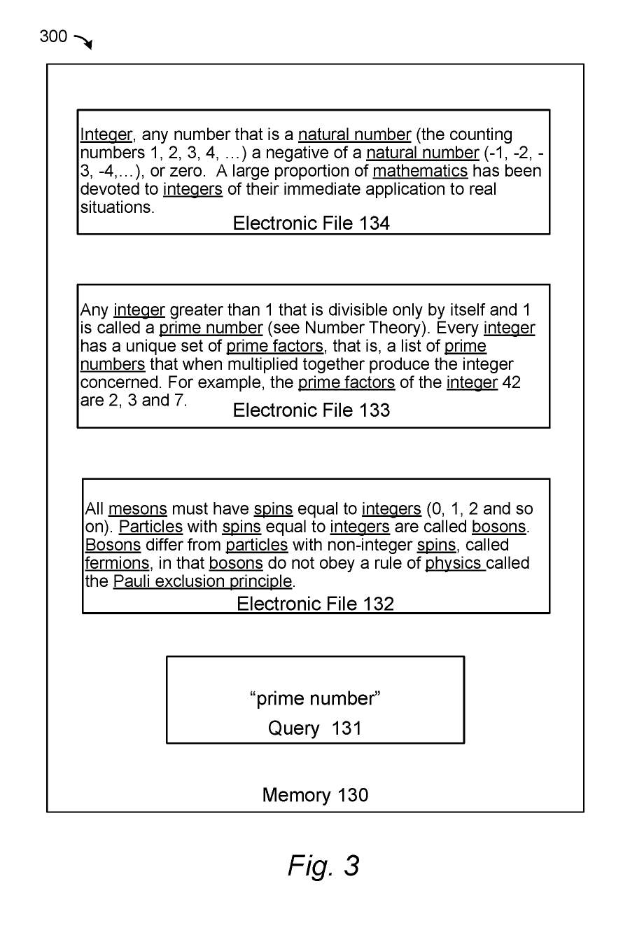

FIG. 3 illustrates text 300 of three electronic files to be searched based on a query, according to embodiments of the present technology. In embodiments, an electronic file may include a text file, word processing file, e-mail or image. In an embodiment, electronic files 132-134 include text in which a set of words (as underlined) are identified as a “lexicon.” In an embodiment, a set of extracted words from one or more electronic files is called a lexicon. A lexicon is used to form a term-document-matrix and query vector as described herein. A query, such as query 131, is identified as a “prime number.” Prime number is considered a single word for this embodiment. According to embodiments of the present technology, electronic files 132-135 are searched based on content in response to a “prime number” query.

FIG. 4 illustrates tables 400 and 401 that identify frequency values of words (or how often a particular word is used) in the lexicon of electronic files 132-134 (identified as d₁, d₂ and d₃) and query 131 (identified as q). As described in detail herein, the frequency values (or column vectors) of tables 400 and 401 are used to form a term-document-matrix and query vector, respectively, used to search electronic files 132-134 based on content.

For example, term-document-matrix A as illustrated in FIG. 6 is represented by three 13^{th} dimensional column vectors having values that indicate the frequency of particular words used in electronic files 132-134, respectfully. A column vector for document d₁ corresponds to 2, 2, 1 . . . , a column vector for document d₂ corresponds to 3, 0, 0 . . . and a column vector for document d₃ corresponds to 2,0,0 . . . . The value “2” in the first entry of a column vector for document d₁ indicates that a term “integer” is used twice in document d₁; while the value “3” in the 8^{th} entry of document d₃ indicates that a term “boson” is used thrice.

For a query vector example (or column vector), table 401 in FIG. 4 (or q in FIG. 6) illustrates a query q represented as a 13^{th} dimensional column vector with a frequency value of “1” as the 4^{th} entry to indicate that “prime number” was used once in query q (all other entries have zero values in this example).

FIG. 5A illustrates a single value decomposition using equation 500 and a geometric interpretation 501 of equation 500. FIG. 5B illustrates resulting term (or topic) vectors (topic space) according to embodiments of the present technology. FIG. 6 illustrates an exemplary single value decomposition of the term-document-matrix represented by the numeric values in table 400 and similarity scores according to embodiments of the present technology.

Provided with n documents (such as documents d₁, d₂ and d₃), a set of words (for instance, nouns, verbs) in the documents may be extracted by natural language process (NLP) technologies, such as NLP 1002 illustrated in FIG. 10. This set of m extracted words w₁, w₂, . . . , wₘ may be considered a “lexicon”. By the lexicon, each document is represented by an m-dimensional vector, in which the i^{th} entry is the frequency (or Boolean or logical value, such as 0 or 1) of the corresponding word wᵢ in this document. Similarly, a query q may be represented by an “m”-dimensional vector, in which the i^{th} entry is the frequency (or Boolean or logical value, such as 0 or 1) of the corresponding word wᵢ in the query. Therefore, the n documents are represented by an m×n matrix, which is called a “term-document-matrix” (for example, see term-document-matrix U in FIGS. 5B or 6). In embodiments, a k-dimensional topic space 521 (see hashed area of term-document-matrix U in FIG. 5B) may then be constructed based on the term-document-matrix as follows.

The construction of a topic space 521, a k-dimensional Euclidean space, is based on singular value decomposition (SVD). That is, any m×n matrix A has a factorization as follows and illustrated in FIGS. 5A, 5B and 6.

In the equation A=UΣV^{T}, where U_{m×n}, V_{n×n} are two orthogonal (orthonormal) matrices, the diagonal matrix Σ=diag(σ₁, σ₂, . . . , σₙ) is composed by the singular values of A, and V^{T} is the transpose of V, as illustrated by equation 500 in FIG. 5A or equation 510 in FIG. 5B.

The first k columns of the matrix U may be denoted by Uₖ. The k-dimensional topic space 521 is spanned by all the column vectors of Uₖ (also known as term vectors). Since these k column vectors are orthonormal (i.e., they are orthogonal and unit vectors), they (a set of scaled columns) act as the coordinate axes of the topic space 521, called basic topics. For convenience, the column vectors of Uₖ are denoted by u₁, u₂, uₖ ∈ R^{m}. Each basic topic (i.e., column vector uᵢ ∈ R^{m}, i=1, 2, . . . , k) is a linear combination of words w₁, w₂, . . . , wₘ.

For any document d ∈ R^{m}, its projection into the topic space 521 is:

$$\hat{d} = ( \begin{matrix}{d}^{T} {u}_{1} \\ {d}^{T} {u}_{2} \\ ⋮ \\ {d}^{T} {u}_{k}\end{matrix} ) = {d}^{T} {U}_{k} ∈ {R}^{k} \qquad ( 1 )$$

In fact, \hat{d} is a new or different representation of the document d, which is a linear combination of the k basic topics. Compared with the previous representation d ∈ R^{m}, the dimension of \hat{d} is reduced to k«m in embodiments.

Similarly, the query q ∈ R^{m} has a new or different representation in the topic space 521 by:

$$\hat{q} = ( \begin{matrix}{q}^{T} {u}_{1} \\ {q}^{T} {u}_{2} \\ ⋮ \\ {q}^{T} {u}_{k}\end{matrix} ) = {q}^{T} {U}_{k} ∈ {R}^{k} \qquad ( 2 )$$

In embodiments, a scale transformation may be applied on the new representation by:

$$\hat{d} = ( \begin{matrix}{d}^{T} {u}_{1} {s}_{1} \\ {d}^{T} {u}_{2} {s}_{2} \\ ⋮ \\ {d}^{T} {u}_{k} {s}_{k}\end{matrix} ) = {d}^{T} {U}_{k} diag ( {s}_{1} , {s}_{2} , … , {s}_{k} ) ∈ {R}^{k} \qquad ( 3 )$$

where s₁, s₂, . . . , sₖ are constants.

For instance, diag(s₁,s₂, . . . , sₖ) can be the k×k identity matrix, or diag(s₁,s₂, . . . , sₖ)=∈ₖ^{∈1}, where ∈ₖ=diag(σ₁,σ₂, . . . , σₖ) is an upper-left submatrix 522 of matrix Σ in the SVD of term-document-matrix A as illustrated in FIG. 5B. In embodiments, diag (s₁, s₂, . . . , sₖ) may be defined as:

diag(s₁,s₂, . . . , sₖ)=\sqrt{Σₖ⁻¹} (4)

In an embodiments, a scale transformation is selected based on a performance of a particular application (e.g., information retrieval, text clustering, etc.) of a topic space. Moreover, s₁, s₂, . . . , sₖ can be even regarded as unknown parameters and trained from labeled training data in embodiments.

FIG. 6 illustrates an exemplary single value decomposition of a term-document-matrix A that has values corresponding to table 400 and a query vector q that has values corresponding to table 401 according to embodiments of the present technology. Term-document-matrix A is decomposed into three matrices: matrix U having a topic space 600 including the first two column vectors of matrix U as well as matrix Σ and matrix V.

Documents d1, d2 and d3 as well as query q are projected into the topic space 600 to obtain linear combinations of the basic topics of topic space 600. For example as shown at 601, \hat{d}₁=(0.2959, 0.3063), \hat{d}₂=(0.5266, 0.7379), \hat{d}₃=(0.7969, −0.6014) and \hat{q}=(0.0346, 0.0946). Similarity scores between each newly represented document and query may be obtained at 602 and a ranking based on a content search may be sorted or ordered at 603. In an embodiment, document d₂ (or electronic file 133) is the most relevant electronic file obtained based on the query “prime number” content based search. Document d₁ (or electronic file 132) is then ranked as more relevant than document d₃ (or electronic file 134) but not as relevant as document d₂. In embodiments, documents may be ranked in different orders, such as from least to most relevant or a predetermined number of relevant documents may be identified.

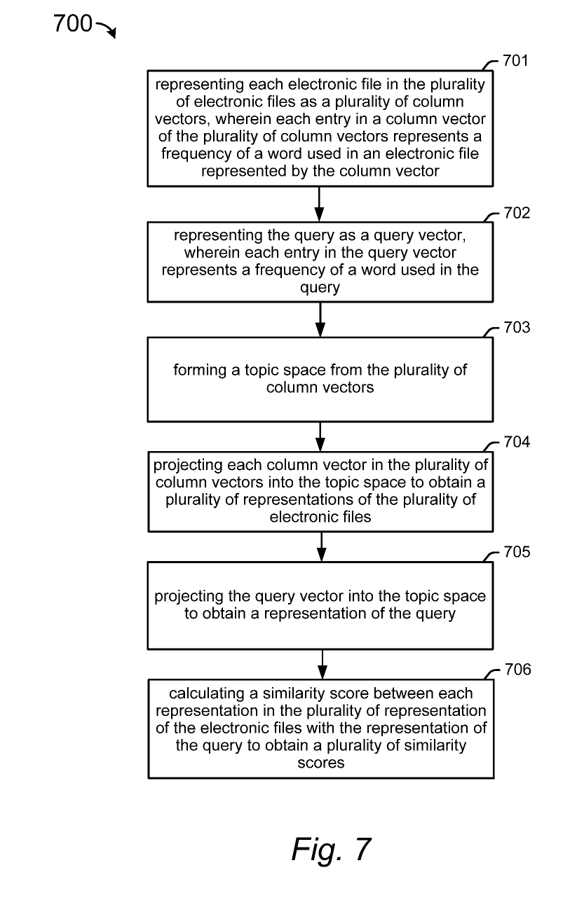

FIG. 7 is a flowchart that illustrates a method 700 for searching a plurality of electronic files based on content according to embodiments of the present technology. In FIG. 7 at 701 the plurality of electronic files is represented as a plurality of column vectors. Each entry in a column vector of the plurality of column vectors represents a frequency of a word used in an electronic file represented by the column vector. In an embodiment, content based search 121, in particular I/O 1001, NLP 1002, lexicon 1003 and/or matrix 1004, executed by processor 110 performs at least a portion of this function.

At 702 a query is represented as a query vector, wherein each entry in the query vector represents a frequency of a word used in the query. In an embodiment, content based search 121 executed by processor 110 performs at least a portion of this function as illustrated in FIGS. 1 and 10. In an embodiment, content based search 121, in particular I/O 1001, NLP 1002, lexicon 1003 and/or matrix 1004, executed by processor 110 performs at least a portion of this function.

At 703 a topic space is formed from the plurality of column vectors. In an embodiment, content based search 121, in particular SVD 1005, executed by processor 110 performs at least a portion of this function.

At 704 each column vector in the plurality of column vectors is projected into the topic space to obtain a plurality of representations of the plurality of electronic files. In an embodiment, content based search 121, in particular projection 1006, executed by processor 110 performs at least a portion of this function.

At 705 the query vector is projected into the topic space to obtain a representation of the query. In an embodiment, content based search 121, in particular projection 1006, executed by processor 110 performs at least a portion of this function.

At 706 a similarity score is calculated between each representation in the plurality of representation of the electronic files with the representation of the query to obtain a plurality of similarity scores. In an embodiment, content based search 121, in particular similar 1007 executed by processor 110 performs at least a portion of this function.

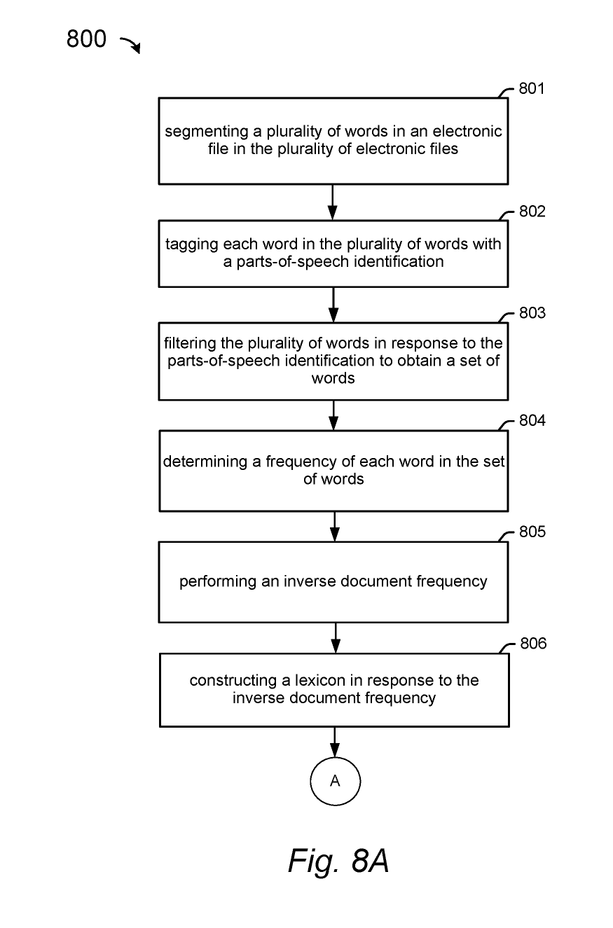

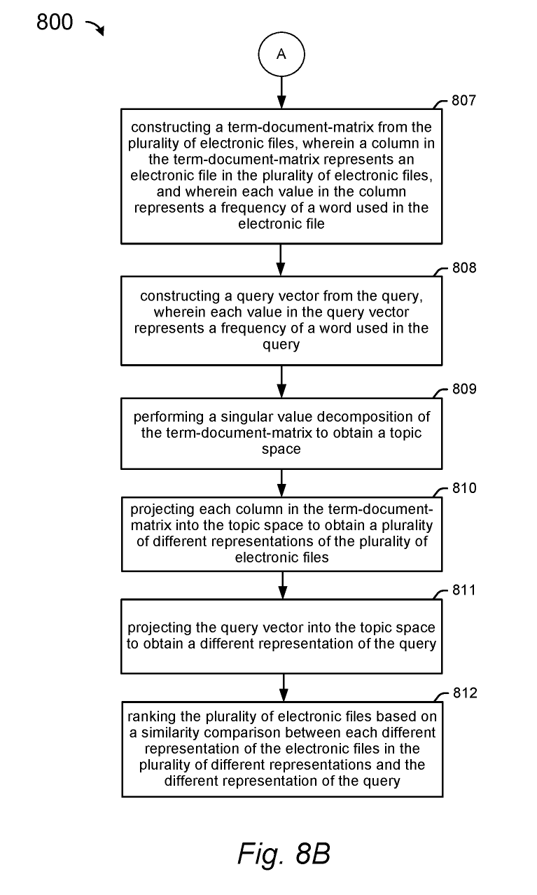

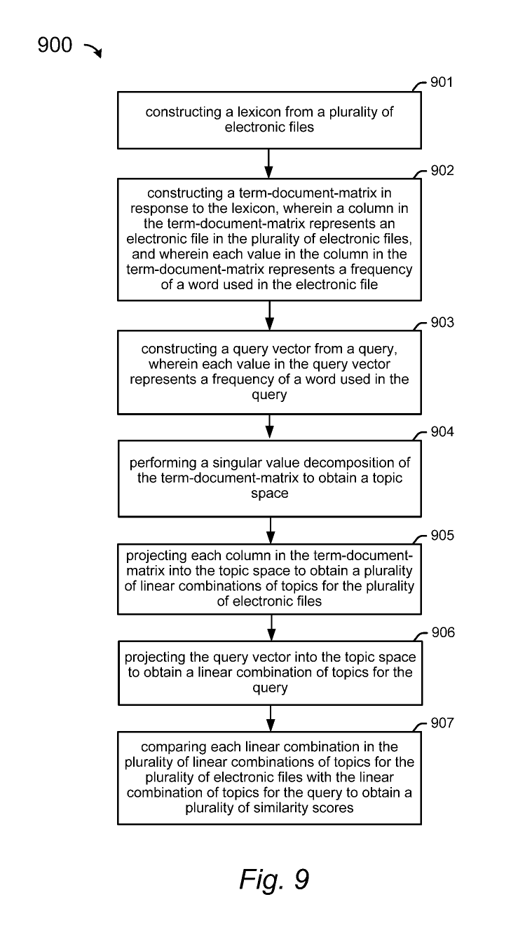

FIGS. 8A-B is a flowchart that illustrates a method 800 for searching electronic files based on content according to embodiments of the present technology. In FIG. 8A at 801 a plurality of words are segmented in an electronic file in the plurality of electronic files. In embodiments, content based search 121, in particular NLP 1002, executed by processor 110 performs at least a portion of this function as well as the functions described below at 802-805.

At 802 each word in the plurality of words is tagged with a parts-of-speech identification.

At 803 the plurality of words is filtered in response to the parts-of-speech identification to obtain a set of words.

At 804 a frequency of each word in the set of words is determined.

At 805 an inverse document frequency is performed.

At 806 a lexicon is constructed in response to the inverse document frequency. In embodiments, content based search 121, in particular lexicon 1003, executed by processor 110 performs at least a portion of this function.

Referring to FIG. 8B, at 807 a term-document-matrix is constructed from the plurality of electronic files. A column in the term-document-matrix represents an electronic file in the plurality of electronic files. Each value in the column represents a frequency of a word used in the electronic file. In embodiments, content based search 121, in particular matrix 1004, executed by processor 110 performs at least a portion of this function.

At 808 a query vector is constructed from the query. Each value in the query vector represents a frequency of a word used in the query. In embodiments, content based search 121, in particular matrix 1004, executed by processor 110 performs at least a portion of this function.

At 809 a singular value decomposition of the term-document-matrix is performed to obtain a topic space. In embodiments, content based search 121, in particular SVD 1005, executed by processor 110 performs at least a portion of this function.

At 810 each column in the term-document-matrix is projected into the topic space to obtain a plurality of different representations of the plurality of electronic files. In embodiments, content based search 121, in particular projection 1006, executed by processor 110 performs at least a portion of this function.

At 811 the query vector is projected into the topic space to obtain a different representation of the query. In embodiments, content based search 121, in particular projection 1006, executed by processor 110 performs at least a portion of this function.

At 812 the plurality of electronic files is ranked based on a similarity comparison between each different representation of the electronic files in the plurality of different representations and the different representation of the query. For example, indications of the plurality of electronic files (file names) are ordered from most to least relevant based on their respective similarity scores with the query. In embodiments, content based search 121, in particular rank 1008, executed by processor 110 performs at least a portion of this function. In embodiments, a list of file names in a particular relevant order may be output (or a subset) or the most relevant file name may be output. In an embodiment, I/O 1001 executed by processor 110 outputs a list of file names and/or the most relevant file name from rank 1008 to user interface 160.

FIG. 9 is a flowchart that illustrates a method 900 for searching electronic files based on content according to embodiments of the present technology.

At 901 a lexicon is constructed from a plurality of electronic files. In embodiments, content based search 121, in particular NLP 1002 and lexicon 1003, executed by processor 110 performs at least a portion of this function.

At 902 a term-document-matrix is constructed in response to the lexicon. A column in the term-document-matrix represents an electronic file in the plurality of electronic files. Each value in the column in the term-document-matrix represents a frequency of a word used in the electronic file. In embodiments, content based search 121, in particular matrix 1004, executed by processor 110 performs at least a portion of this function as well as the function at 903.

At 903 a query vector is constructed from a query. Each value in the query vector represents a frequency of a word used in the query.

At 904 a singular value decomposition of the term-document-matrix is performed to obtain a topic space. In embodiments, content based search 121, in particular SVD 1005, executed by processor 110 performs at least a portion of this function

At 905 each column in the term-document-matrix is projected into the topic space to obtain a plurality of linear combinations of topics for the plurality of electronic files. In embodiments, content based search 121, in particular projection 1006, executed by processor 110 performs at least a portion of this function as well as the function at 906.

At 906 the query vector is projected into the topic space to obtain a linear combination of topics for the query.

At 907 each linear combination in the plurality of linear combinations of topics for the plurality of electronic files is compared with the linear combination of topics for the query to obtain a plurality of similarity scores. In an embodiment, content based search 121, in particular similar 1007 executed by processor 110 performs at least a portion of this function.

Returning to FIG. 1, computing device 101 may include a processor 110, memories 120 and 130, user interface 160 and network interface 140 that communicate via a signal path, such as interconnect 170. Interconnect 170 may include a bus for transferring signals having one or more type of architectures, such as a memory bus, memory controller, a peripheral bus or the like.

Computing device 101 may be implemented in various embodiments. Computing devices may utilize all of the hardware and software components shown, or a subset of the components in embodiments. Levels of integration may vary depending on an embodiment. For example, memories 120 and 130 may comprise many more memories. Furthermore, a computing device 101 may contain multiple instances of a component, such as multiple processors (cores), memories, databases, transmitters, receivers, etc. Computing device 101 may comprise a processor equipped with one or more input/output devices, such as network interfaces, storage interfaces, and the like.

In an embodiment, computing device 101 may be, or be a part of, a mainframe computer that accesses a large amount of data related to a cellular network stored in a database. In alternate embodiment, computing device 101 may be embodied as different type of computing device. In an embodiment, types of computing devices include but are not limited to, controller, laptop, desktop, embedded, server, mainframe and/or super (computer).

Memory 120 stores content based search 121 that include computer instructions embodied in computer programs. In embodiments, other computer programs such as an operating system having a scheduler, application(s) and a database are stored in memory 120. In an embodiment, computer programs for storing and retrieving data are stored in memory 120. In an embodiment, electronic files 132-134 and query 131 are stored in memory 130. In an embodiment, memories 120 and 130 may comprise a single memory.

In an embodiment, processor 110 may include one or more types of electronic processors having one or more cores. In an embodiment, processor 110 is an integrated circuit processor that executes (or reads) computer instructions that may be included in code and/or computer programs stored on a non-transitory memory to provide at least some of the functions described herein. In an embodiment, processor 110 is a multi-core processor capable of executing multiple threads. In an embodiment, processor 110 is a digital signal processor, baseband circuit, field programmable gate array, digital logic circuit and/or equivalent.

A thread of execution (thread or hyper thread) is a sequence of computer instructions that can be managed independently in one embodiment. A scheduler, which may be included in an operating system, may also manage a thread. A thread may be a component of a process, and multiple threads can exist within one process, executing concurrently (one starting before others finish) and sharing resources such as memory, while different processes do not share these resources. In an embodiment, the threads of a process share its instructions (executable code) and its context (the values of the process's variables at any particular time).

Memory 120 (as well as memory 130) may comprise any type of system memory such as static random access memory (SRAM), dynamic random access memory (DRAM), synchronous DRAM (SDRAM), read-only memory (ROM), a combination thereof, or the like. In an embodiment, a memories 120 and 130 may include ROM for use at boot-up, and DRAM for program and data storage for use while executing computer instructions. In embodiments, memories 120 and 130 are non-transitory or non-volatile integrated circuit memory storage. Similarly, storages described herein may be non-transitory or non-volatile integrated circuit memory storage.

Further, memories 120 and 130 may comprise any type of memory storage device configured to store data, store computer programs including instructions, and store other information and to make the data, computer programs, and other information accessible via interconnect 170. Memories 120 and 130 may comprise, for example, one or more of a solid state drive, hard disk drive, magnetic disk drive, optical disk drive, or the like. Similarly, storages as described herein may be one or more of a solid state drive, hard disk drive, magnetic disk drive, optical disk drive, or the like in embodiments.

Computing device 101 also includes one or more network interfaces 140, which may comprise wired links, such as an Ethernet cable or the like, and/or wireless links to access network 150. A network interface 140 allows computing device 101 to communicate with network 150 that may include other memory and/or computing devices.

In an embodiment, network 150 may include wired or wireless connections, singly or in combination. In an embodiment, network 150 may include the Internet, a wide area network (WAN) or a local area network (LAN), singly or in combination.

In an embodiment, network 150 may include a High Speed Packet Access (HSPA) network, or other suitable wireless systems, such as for example Wireless Local Area Network (WLAN) or Wi-Fi (Institute of Electrical and Electronics Engineers' (IEEE) 802.11x). In an embodiment, computing device 101 uses one or more protocols to transfer information or packets, such as Transmission Control Protocol/Internet Protocol (TCP/IP) packets.

In embodiments, computing device 101 includes input/output (I/O) computer instructions as well as hardware components, such as I/O circuits to receive and output information from and to other computing devices and or networks, via network 150. In an embodiment, an I/O circuit may include at least a transmitter and receiver circuit that may be included in network interface 140.

User interface 160 may include computer instructions as well as hardware components in embodiments. A user interface 160 may include input devices such as a touchscreen, microphone, camera, keyboard, mouse, pointing device and/or position sensors. Similarly, a user interface 160 may include output devices, such as a display, vibrator and/or speaker, to output images, characters, vibrations, speech and/or video as an output. A user interface 160 may also include a natural user interface where a user may speak, touch or gesture to provide input.

FIG. 10 illustrates a software architecture 1000 to search electronic files based on content according to embodiments of the present technology. In embodiments, software components illustrated in software architecture 1000 are stored in memory 120 of FIG. 1. In embodiments, software components illustrated in FIG. 10 may be embodied as a computer program, object, function, subroutine, method, software instance, script, a code fragment, stored in an electronic file, singly or in combination. In order to clearly describe the present technology, software components shown in FIG. 10 are described as individual software components. In embodiments, the software components illustrated in FIG. 10, singly or in combination, may be stored (in single or distributed computer-readable storage medium(s)) and/or executed by a single or distributed computing device (processor or multi-core processor) architecture. Functions performed by the various software components described herein are exemplary. In other embodiments, software components identified herein may perform more or less functions. In embodiments, software components may be combined or further separated.

In embodiments, software architecture 1000 includes content based search 121 which includes input/output (I/O) 1001, NLP 1002, lexicon 1003, matrix (term-document-matrix) 1004, SVD 1005, projection 1006, similar 1007 and rank 1008.

I/O 1001 is responsible for, among other functions, providing inputs and outputs to content based search 121. For example, I/O 1001 may receive a plurality of electronic files and a query, such as electronic files 132-134 as well as query 131, and output a search result based on content. In an embodiment, electronic files and/or a query may be received from a network, such as the Internet. In an embodiment, a search result based on content may be output to user interface 160 as illustrated in FIG. 1. A search result based on content may indicate the most relevant electronic file discovered or a list (or rank order) of relevant electronic files in a particular order, such as from most relevant to least relevant to the query. In an embodiment, I/O 1001 outputs a search result based on content from either rank 1008 and/or similar 1007.

NLP 1002 is responsible for, among other functions, processing an electronic file to identify and/or obtain information regarding the electronic file, such as the text in an electronic file. In embodiments, NLP 1002 is responsible for segmenting and/or tagging words in an electronic file, such electronic files 132-134, with parts-of-speech (POS) identifications. In embodiments, NLP 1002 is responsible for filtering identified words by POS. In embodiments, NLP 1002 is responsible for calculating a frequency of a term or word used in an electronic file as well as an inverse document frequency. In an embodiment, NLP 1002 is responsible for determining an inverse document frequency

Lexicon 1003 is responsible for, among other functions, constructing a lexicon of a plurality of electronic files. In an embodiment, a lexicon is a set of words w₁, w₂, . . . , wₘ that are included in a plurality of electronic files. For example, FIG. 4 illustrates a lexicon of electronic files 132-134 that includes “integer,” “natural number,” “mathematics,” . . . and “Pauli exclusion principle.” In other words, the lexicon illustrated in FIG. 4 includes the set of words that are underlined in electronic files 132-134 as illustrated in FIG. 3.

Matrix 1004 is responsible for, among other functions, constructing a term-document-matrix and a query vector from a plurality of electronic files and a query. For example, the values associated with table 400 in FIG. 4 or a term-document-matrix A in FIG. 6 illustrates a term-document-matrix from electronic files 132-134. In an embodiment, each document, such as documents d₁-d₃ (which correspond to electronic files 132-134 in an embodiment), may be represented as an m-dimensional vector, in which the i^{th} entry is a frequency (or Boolean or logical value, such as 0 or 1) of the corresponding term or word wᵢ being used in the document.

Similarly, a query vector may be represented as the values associated with table 401 or a 13^{th} dimensional column vector. Similarly to a term-document-matrix, a query may be represented as an m-dimensional column query vector, in which the i^{th} entry is a frequency (or Boolean or logical value, such as 0 or 1) of the word wᵢ used in the query.

SVD 1005 is responsible for, among other functions, performing a singular value decomposition as described herein. For example, SVD 1005 decomposes a matrix, such as a term-document-matrix A to a matrix U, matrix Σ and matrix V as illustrated in FIGS. 5A, 5B and 6. In an embodiment, sparse matrix functions and/or methods may be used. In an embodiment, SVD 1005 performs a SVD in order to obtain a topic space for a plurality of electronic files, for example the first two columns (or k-dimensional topic space) of a matrix U as illustrated in FIGS. 5B and 6.

Projection 1006 is responsible for, among other functions, projecting vectors into the topic space or calculating linear combinations of topics (or numbers representing them) for documents d₁-d₃ and query q. In embodiments, documents d₁-d₃ and query q represented as column vectors are projected into the topic space 600 as illustrated 601 in FIG. 6 in order to obtain linear combinations of topics.

Similar 1007 is responsible for, among other functions, calculating a similarity or similarity score between each documents d₁-d₃ and query q. In embodiments, a cosine similarity (cos) or Jaccard similarity coefficient is used. A plurality of similarity scores may be calculated as illustrated in equations 602 of FIG. 6 to indicate how similar the content of each document is to a particular query. In an embodiment, similar 1007 measures a distance between projections of the plurality of electronic files on the topic space with a projection of the query on the topic space.

Rank 1008 is responsible for, among other functions, ranking or ordering an indication of the relevance (or relative relevance) of each electronic file to a particular query. In an embodiment, rank 1008 provides an indication, such as a file name, of the most relevant electronic file. In other embodiments, rank 1008 provides an ordered list of relevant file names ordered from most relevant to least relevant based on its similarity score. For example, list 603 as illustrated in FIG. 6 indicates that document d₂ is the most relevant document to query q followed in order of relevancy by document d₁ and d₃ based on the similarity scores of equation 602. In embodiments, rank 1008 provides only a portion of the ordered list up to a threshold value and/or hyperlinks to each electronic file.

Advantages of the present technology may include, but are not limited to, bringing more convenience to users in discovering relevant documents, e-mails and even images in a search from a computing device, such as a mobile phone. Since topic distribution depends on the file content, topic based intelligent searching may be helpful in improving personalization. Embodiments of the present technology are consistent with string/word matching methods; while improving a user's experience in file searching.

The flowcharts and block diagrams in the figures illustrate the architecture, functionality, and operation of possible implementations of a device, apparatus, system, computer-readable medium and method according to various aspects of the present disclosure. In this regard, each block (or arrow) in the flowcharts or block diagrams may represent operations of a system component, software component or hardware component for implementing the specified logical function(s). It should also be noted that, in some alternative implementations, the functions noted in the block may occur out of the order noted in the figures. For example, two blocks (or arrows) shown in succession may, in fact, be executed substantially concurrently, or the blocks (or arrows) may sometimes be executed in the reverse order, depending upon the functionality involved. It will also be noted that each block (or arrow) of the block diagrams and/or flowchart illustration, and combinations of blocks (or arrows) in the block diagram and/or flowchart illustration, can be implemented by special purpose hardware-based systems that perform the specified functions or acts, or combinations of special purpose hardware and computer instructions.

It will be understood that each block (or arrow) of the flowchart illustrations and/or block diagrams, and combinations of blocks (or arrows) in the flowchart illustrations and/or block diagrams, may be implemented by non-transitory computer instructions. These computer instructions may be provided to and executed (or read) by a processor of a general purpose computer (or computing device), special purpose computer, or other programmable data processing apparatus to produce a machine, such that the instructions executed via the processor, create a mechanism for implementing the functions/acts specified in the flowcharts and/or block diagrams.

As described herein, aspects of the present disclosure may take the form of at least a system, a device having one or more processors executing instructions stored in non-transitory memory, a computer-implemented method, and/or a non-transitory computer-readable storage medium storing computer instructions.

Non-transitory computer-readable media includes all types of computer-readable media, including magnetic storage media, optical storage media, and solid state storage media and specifically excludes signals. It should be understood that software including computer instructions can be installed in and sold with a computing device having computer-readable storage media. Alternatively, software can be obtained and loaded into a computing device, including obtaining the software via a disc medium or from any manner of network or distribution system, including, for example, from a server owned by a software creator or from a server not owned but used by the software creator. The software can be stored on a server for distribution over the Internet, for example.

More specific examples of the computer-readable medium include the following: a portable computer diskette, a hard disk, a random access memory (RAM), ROM, an erasable programmable read-only memory (EPROM or Flash memory), an appropriate optical fiber with a repeater, a portable compact disc read-only memory (CD-ROM), an optical storage device, a magnetic storage device, or any suitable combination thereof.

Non-transitory computer instructions used in embodiments of the present technology may be written in any combination of one or more programming languages.

The programming languages may include an object oriented programming language such as Java, Scala, Smalltalk, Eiffel, JADE, Emerald, C++, CII, VB.NET, Python, R or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The computer instructions may be executed entirely on the user's computer (or computing device), partly on the user's computer, as a stand-alone software package, partly on the user's computer and partly on a remote computer, or entirely on the remote computer or server. In the latter scenario, the remote computer may be connected to the user's computer through any type of network, or the connection may be made to an external computer (for example, through the Internet using an Internet Service Provider) or in a cloud computing environment or offered as a service such as a Software as a Service (SaaS).

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Although the subject matter has been described in language specific to structural features and/or methodological steps, it is to be understood that the subject matter defined in the appended claims is not necessarily limited to the specific features or steps (acts) described above. Rather, the specific features and steps described above are disclosed as example forms of implementing the claims.

What is claimed is:

1. An apparatus comprising:
a non-transitory memory storing a query for a plurality of electronic files and instructions; and
one or more processors in communication with the non-transitory memory, wherein the one or more processors execute the instructions to:
represent the plurality of electronic files as a plurality of column vectors, wherein each entry in a column vector of the plurality of column vectors represents a frequency of a word used in an electronic file represented by the column vector;
represent the query as a query vector, wherein each entry in the query vector represents a frequency of a word used in the query;
form a topic space from the plurality of column vectors;
project each column vector in the plurality of column vectors into the topic space to obtain a plurality of representations of the plurality of electronic files;
project the query vector into the topic space to obtain a representation of the query; and
calculate a similarity score between each representation in the plurality of representations of the electronic files with the representation of the query to obtain a plurality of similarity scores.

2. The apparatus of claim 1, wherein the plurality of column vectors form a term-document-matrix, and wherein the plurality of representations of the plurality of electronic files include a plurality of linear combinations of topics represented as a plurality of numbers.

3. The apparatus of claim 2, wherein forming the topic space includes calculating a singular value decomposition of the term-document-matrix to obtain the topic space.

4. The apparatus of claim 3, wherein the topic space includes at least two orthogonal column vectors from a first matrix calculated from the singular value decomposition.

5. The apparatus of claim 4, wherein the plurality of column vectors are m-dimensional column vectors and the topic space is a k-dimensional topic space, wherein k is less than m.

6. The apparatus of claim 1, further comprising the one or more processors execute the instructions to:
rank the plurality of similarity scores; and
output a result that indicates an electronic file in the plurality of electronic files that is most relevant to the query.

7. A computer-implemented method for searching a plurality of electronic files in response to a query, the method comprising:
constructing a term-document-matrix from the plurality of electronic files, wherein a column in the term-document-matrix represents an electronic file in the plurality of electronic files, and wherein each value in the column represents a frequency of a word used in the electronic file;
constructing a query vector from the query, wherein each value in the query vector represents a frequency of a word used in the query;
performing a singular value decomposition of the term-document-matrix to obtain a topic space;
projecting each column in the term-document-matrix into the topic space to obtain a plurality of different representations of the plurality of electronic files;
projecting the query vector into the topic space to obtain a different representation of the query; and
ranking the plurality of electronic files based on a similarity comparison between each different representation of the electronic files in the plurality of different representations and the different representation of the query.

8. The computer-implemented method of claim 7, further comprising:
segmenting a plurality of words in an electronic file in the plurality of electronic files;
tagging each word in the plurality of words with a parts-of-speech identification;
filtering the plurality of words in response to the parts-of-speech identification to obtain a set of words;
determining a frequency of each word in the set of words;
performing an inverse document frequency; and
constructing a lexicon in response to the inverse document frequency.

9. The computer-implemented method of claim 8, wherein the lexicon and the plurality of words with the parts-of-speech identification are used to form the term-document-matrix.

10. The computer-implemented method of claim 7, wherein performing the singular value decomposition of the term-document-matrix to obtain the topic space comprises:
forming a first, second and third matrix,
wherein the first and third matrix are orthonormal matrices and the second matrix is a diagonal matrix, and
wherein the topic space is spanned by k orthonormal column vectors in the first matrix.

11. The computer-implemented method of claim 10, wherein a set of scaled columns in the first matrix act as a coordinate axes of the topic space.

12. The computer-implemented method of claim 8, further comprising:
receiving the query; and
receiving the plurality of electronic files, wherein the plurality of electronic files include at least one of a text file, a word processing file, an e-mail, or an image.

13. The computer-implemented method of claim 12, further comprising:
outputting an indication as to a relevance of each of the electronic files in the plurality of electronic files with respect to the query, with the relevance based on the similarity comparison.

14. The computer-implemented method of claim 13, wherein the similarity comparison uses one of a cosine similarity or a Jaccard similarity coefficient.

15. A non-transitory computer-readable medium storing computer instructions, that when executed by one or more processors, cause one or more processors to perform the steps of:
construct a lexicon from a plurality of electronic files;
construct a term-document-matrix in response to the lexicon, wherein a column in the term-document-matrix represents an electronic file in the plurality of electronic files, and wherein each value in the column in the term-document-matrix represents a frequency of a word used in the electronic file;
construct a query vector from a query, wherein each value in the query vector represents a frequency of a word used in the query;
perform a singular value decomposition of the term-document-matrix to obtain a topic space;
project each column in the term-document-matrix into the topic space to obtain a plurality of linear combinations of topics for the plurality of electronic files;
project the query vector into the topic space to obtain a linear combination of topics for the query; and
compare each linear combination in the plurality of linear combinations of topics for the plurality of electronic files with the linear combination of topics for the query to obtain a plurality of similarity scores.

16. The non-transitory computer-readable medium of claim 15, wherein the lexicon includes a set of extracted words from a plurality of words in the plurality of electronic files,
wherein the plurality of electronic files include at least one of a text file, word processing file, e-mail and image.

17. The non-transitory computer-readable medium of claim 16, wherein construct a lexicon comprises:
segment the plurality of words in an electronic file in the plurality of electronic files;
tag each word in the plurality of words with a parts-of-speech identification;
filter the plurality of words in response to the parts-of-speech identification to obtain a set of words;
determine a frequency of each word in the set of words;
perform an inverse document frequency; and
construct the lexicon in response to the inverse document frequency.

18. The non-transitory computer-readable medium of claim 16, wherein perform the singular value decomposition of the term-document-matrix to obtain the topic space comprises:
form a first, second and third matrix,
wherein the first and third matrix are orthonormal matrices and the second matrix is a diagonal matrix,
wherein the topic space is spanned by k orthonormal column vectors in the first matrix, and
wherein a set of scaled columns in the first matrix act as a coordinate axes of the topic space.

19. The non-transitory computer-readable medium of claim 16, wherein the compare uses one of a cosine similarity or a Jaccard similarity coefficient.

20. The non-transitory computer-readable medium of claim 19, wherein the steps further comprise:
rank the plurality of similarity scores corresponding to the plurality of electronic files; and
output an indication as to a relevancy of at least one of the electronic files in the plurality of electronic files with respect to the query.
